(19) United States
(12) Patent Application Publication
(10) Pub. No.: US 2012/0285971 A1
(43) Pub. Date: Nov. 15, 2012

(54) INTEGRATED VACUUM INSULATION PANEL

(75) Inventors: Brent Alden Junge, Evansville, IN (US); Steven Douglas Wetherholt, Franklin, TN (US)

(73) Assignee: GENERAL ELECTRIC COMPANY, Schenectady, NY (US)

(21) Appl. No.: 13/103,315

(22) Filed: May 9, 2011

(51) Int. Cl. F25D 23/00; B23K 1/00; B23K 31/02; B23P 15/26

(52) U.S. Cl. 220/592.02; 29/890.035; 228/221

(57) ABSTRACT

In certain embodiments of the present disclosure, a refrigerator is described. The refrigerator includes an inner liner defining a storage compartment. The refrigerator further includes an outer wall forming a vacuum insulation panel. The outer wall defines a hermetically sealed vacuum compartment wall. The compartment includes filler insulating material and is evacuated of atmospheric gases. The compartment is located between the outer wall and the inner liner.

### FIELD OF THE INVENTION

The present disclosure relates to an integrated vacuum insulation panel.

### BACKGROUND OF THE INVENTION

A vacuum insulated panel is a form of thermal insulation made up of a nearly gas-tight enclosure surrounding a rigid core, from which the air has been evacuated. Vacuum insulation panels have a number of different applications, including for use inside refrigerator cabinets. In refrigerator applications, separate vacuum insulation panels are utilized in combination with conventional foam or fiberglass insulation within the walls of the refrigerator. Such vacuum insulation panels are used to decrease the heat leakage into a refrigerator and therefore decrease the energy required to operate the refrigerator. The vacuum insulation panels are typically attached to the metal refrigerator case prior to inserting insulating material.

Unfortunately, conventional vacuum insulation panels result in efficiency losses at the edges between adjacent panels. Certain vacuum insulation panels are described which can interlock with one another in an effort to reduce such losses. However, interlocking vacuum insulation panels still encounter edge losses and also require additional material and manufacturing complexity.

Accordingly, a vacuum insulation panel which can maximize efficiency while decreasing manufacturing complexity would be desirable. A refrigerator incorporating such a vacuum insulation panel would be particularly useful.

### BRIEF DESCRIPTION OF THE INVENTION

Aspects and advantages of the disclosure will be set forth in part in the following description, or may be obvious from the description, or may be learned through practice of the disclosure.

In certain embodiments of the present disclosure, a refrigerator is described. The refrigerator includes an inner liner defining a storage compartment. The refrigerator further includes an outer wall forming a vacuum insulation panel. The outer wall defines a hermetically sealed vacuum compartment wall. The compartment includes filler insulating material and is evacuated of atmospheric gases. The compartment is located between the outer wall and the inner liner.

In yet other embodiments of the present disclosure, a method of assembling a refrigerator is described. The method includes joining an inner liner defining a storage compartment with an outer wall. The outer wall forms a vacuum insulation panel. The outer wall defines a hermetically sealed vacuum compartment wall. The compartment includes filler insulating material and is evacuated of atmospheric gases. The compartment is located between the outer wall and the inner liner.

These and other features, aspects and advantages of the present disclosure will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure, including the best mode thereof, directed to one of ordinary skill in the art, is set forth in the specification, which makes reference to the appended figures, in which:

FIG. 1 provides a perspective view of an example refrigerator in accordance with certain aspects of the present disclosure.

FIG. 2 is a bottom view of the outer case vacuum panel in accordance with certain aspects of the present disclosure.

FIG. 3 is a section view taken along line 2-2 of FIG. 1 in accordance with certain aspects of the present disclosure.

FIG. 4 is a detailed sectional view of the evacuation opening in accordance with certain aspects of the present disclosure.

FIG. 5 illustrates a side wall joined with a top wall in accordance with certain aspects of the present disclosure.

### DETAILED DESCRIPTION OF THE INVENTION

The present disclosure relates to vacuum insulation panels that are integrally formed with the outer wall of a refrigerator. Utilization of such vacuum insulation panels provides a vacuum seal without the necessity for an additional vacuum insulation panel to be attached thereto, which can save materials and manufacturing costs. In addition, the vacuum insulation panels of the present disclosure can increase cabinet stiffness and strength through the sandwich construction described herein. Furthermore, the edges of the vacuum insulation panels are in the corners of the refrigerator outer wall where any additional heat loss can more easily be minimized. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

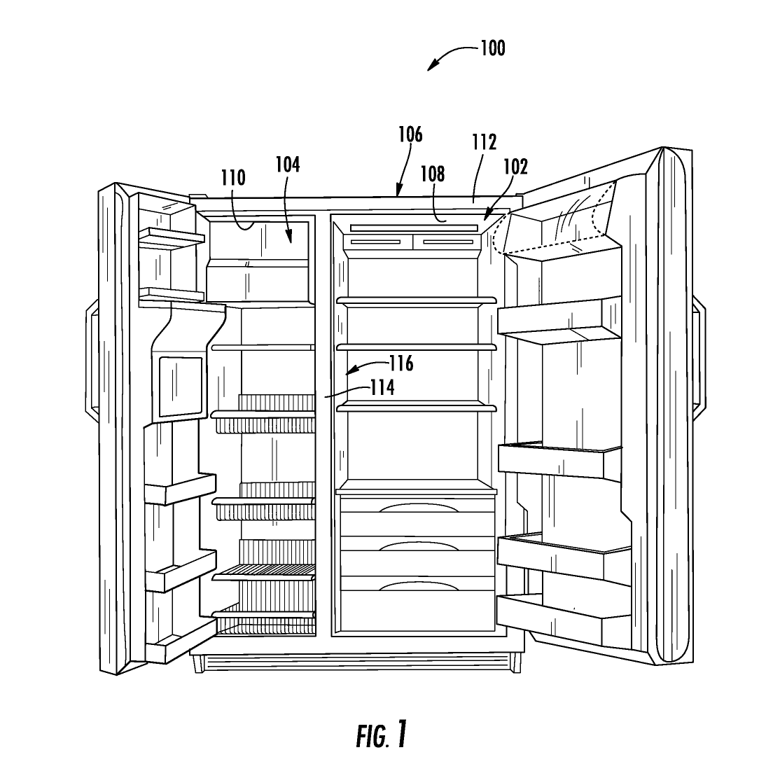

FIG. 1 is a perspective view of an exemplary refrigerator 100 in which exemplary embodiments of the present invention may be practiced and for which the benefits of the invention may be realized. It is apparent to those skilled in the art and guided by the teachings herein provided that the apparatus and/or method, as described herein, may likewise be practiced in any suitable refrigerator. Therefore, refrigerator 100 as described and illustrated herein is for illustrative purposes only and is not intended to limit the herein described apparatus and/or method in any aspect.

FIG. 1 illustrates a side-by-side refrigerator 100 including a fresh food storage compartment 102 and a freezer storage compartment 104. Fresh food compartment 102 and freezer compartment 104 are arranged side-by-side. In one embodiment, refrigerator 100 is a commercially available refrigerator from General Electric Company, Appliance Park, Louisville, Ky. 40225, and is modified to incorporate the herein described apparatus. It is apparent to those skilled in the art and guided by the teachings herein provided that the present invention is suitable for incorporation into other types of refrigeration appliances including, without limitation top and bottom mount refrigerators.

Fresh food storage compartment 102 and freezer storage compartment 104 are contained within an outer case 106 having inner liners 108 and 110. In accordance with the present disclosure, outer case 106 is formed from one or more vacuum insulation panels.

Advantageously, the present inventors have determined that one or more vacuum insulation panels can be used to form outer case 106 rather than attaching such panels to the outer case as separate components. The space between outer case 106 and inner liners 108 and 110, is typically filled with separate vacuum insulation panels and/or foamed-in-place insulation. Such separate vacuum insulation panels are typically adhesively secured to outer case and also typically include duplicative materials, such as duplicate metal walls or the like. As further described herein in accordance with the present disclosure, outer case 106 is integrally formed by one or more vacuum insulation panels. In particular, outer case can include a top wall, back wall, and/or side walls that are independently formed from a vacuum insulation panel and then joined to one another to create outer case 106. In this embodiment, outer case 106 side walls, back wall, and top wall are formed separately (each integrally including one or more vacuum insulation panels) and are joined to a bottom frame that provides support for refrigerator 100.

In this regard, any suitable method for forming such a vacuum insulation panel can be utilized. For instance, U.S. Pat. No. 5,826,780 entitled “Vacuum insulation panel and method for manufacturing,” incorporated by reference herein, describes one suitable method of forming a vacuum insulation panel that can be modified for use as a refrigerator outer case.

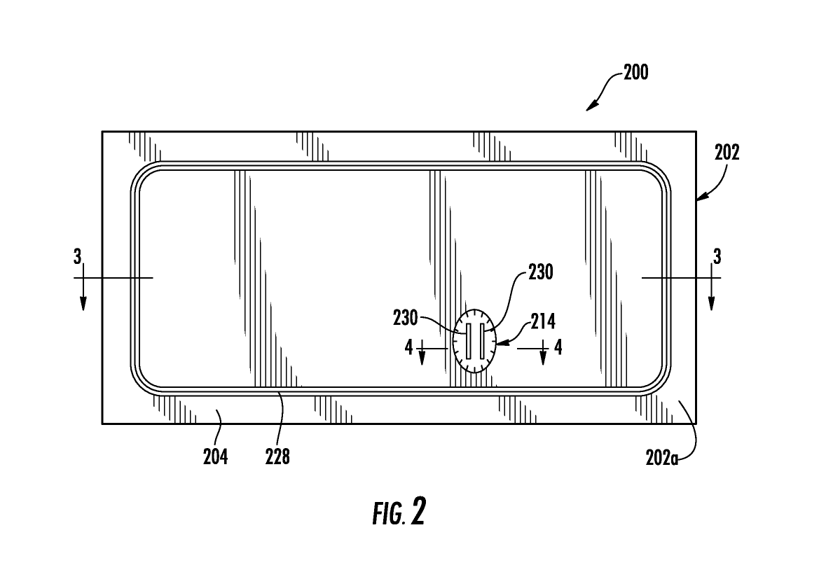

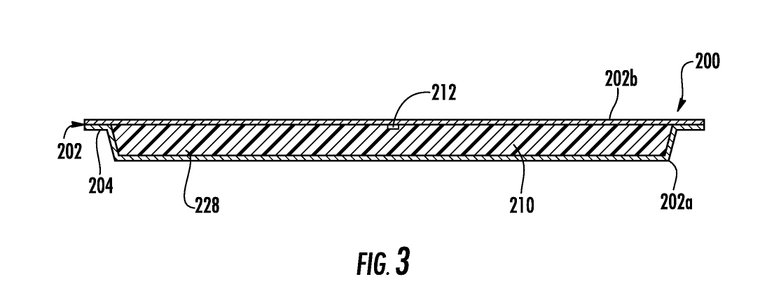

Briefly, the method includes forming suitable outer case wall shape having a cavity 228 for receiving the insulating media and a flat flange extending around the periphery thereof. Referring more particularly to FIGS. 2 and 3, the vacuum panel is shown generally at 200 and includes metal jacket 202. The jacket 202 includes a bottom 202a and a top 202b. An evacuation port or opening is formed in bottom 202a or top 202b to provide a vacuum as will hereinafter be described. The flange 204 can be flat and wrinkle free to permit a hermetic seal with top 202b. The top which can be flat is welded to flange 204 to create the hermetic seal using any suitable technique including laser welding or a roll resistance seam welding process.

Both the jacket top and bottom can be made stainless steel, aluminum, or the like. For example, steel as is typically used for the outer case of a refrigerator can be utilized. Disposed in jacket 202 is an insulating media 210.

Insulating media 210 can be any suitable insulation including fiberglass, foamed insulation, such as open cell foamed insulation, or the like. The dense media opposes atmospheric pressure that tends to collapse the jacket after the panel is evacuated. The media also has minimal outgassing, low cost, low thermal conductivity, low emissivity and a high melting temperature. To reduce the panel evacuation time and improve vacuum life, it is preferable to bake out the media to approximately 600° F. to drive off the moisture and gases in the media before it is sealed in the jacket. This can be accomplished by prebaking the panel while the media is at atmospheric pressure. The prebake significantly reduces the evacuation cycle time by reducing the quantity of air molecules contained in the jacket. Subsequent evacuation in a vacuum chamber is then quickly and efficiently accomplished.

Also located in jacket 202 is a getter system 212. Once activated, a getter will absorb most residual gases (i.e., H₂, O₂, N₂) and water vapor to maintain the vacuum in the panel throughout its extended life.

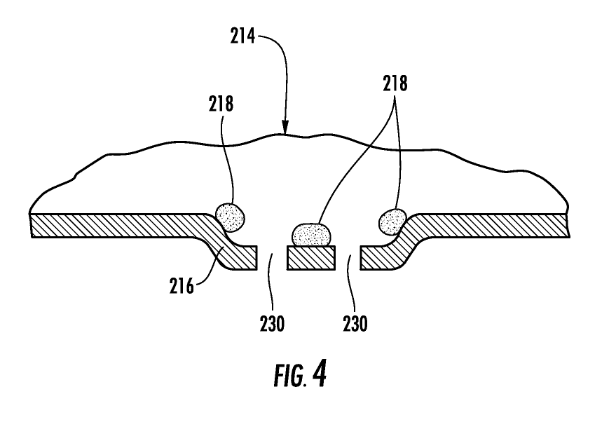

To create a vacuum in the panel, an opening 214 is provided in the bottom 202a (or alternately the top 202b) that communicates the inside of the panel with the atmosphere as best shown in FIG. 4. The evacuation opening 214 is formed in a recess 216. A nickel based braze material 218 is located in recess 216 adjacent, but not blocking the openings which may simply be narrow slots 230. When heated to approximately 1800° F. brazing material 218 will melt and seal the slots 230 to create a hermetic seal. Recess 216 can retain the molten braze 218 prior to cooling. Any suitable brazing material can be utilized, although the brazing material should have good wetting characteristics to stainless steel without flux, low melting temperature, low base metal erosion, and high ductility (to flex with metal foil). To permit maximum slot width for quick evacuation while still ensuring a hermetic seal, the nickel-braze paste is mixed with a micro-gap filler which consists of a fine particulate which does not melt at the braze temperature. Finally, the braze material should be zinc and cadmium free because these elements will vaporize in a vacuum.

In a preferred embodiment, the panel is preheated to approximately 600° F. in an oven at atmospheric pressure to reduce the panel's internal air density (by up to one-half) and to energize the air and other volatiles. The gas composition in this prebake oven can be dry air or an oxygen free gas mixture as necessary to prevent oxidation of braze or foil panel components or chrome depletion. This preconditions the panel for efficient evacuation. The panel is then promptly placed in a vacuum chamber while it is still hot. Typically, this should occur within about five minutes of the preheat step to obtain maximum benefits. As a result of the atmospheric preheat followed by evacuation of the panel in a vacuum chamber, optimum vacuum levels can be achieved which are not easily obtained without the preheat step. For example, using an atmospheric preheat of 30 to 40 minutes at approximately 600° F. followed by vacuum chamber evacuation, a vacuum of ten microns (mercury) can be obtained within twenty-five minutes. Without the preheat step (instead using a simultaneous heat and evacuate technique, i.e. a one-step technique) typical vacuum results are 100 microns in approximately sixty minutes.

In an alternative embodiment which does not utilize a preheat step, a heated vacuum chamber is used to evacuate and seal the panel and to activate the getter. The panel is inserted in the chamber where the temperature and vacuum are gradually increased in steps. As the temperature and vacuum increase, the insulating media is preheated, outgassing is achieved, the getter is activated and the braze is melted to seal the panel.

In order to increase the speed for formation of the outer case wall, a vacuum pump can be utilized as would be understood by one of ordinary skill in the art to further evacuate the interior space of the panel prior to melting the brazing material.

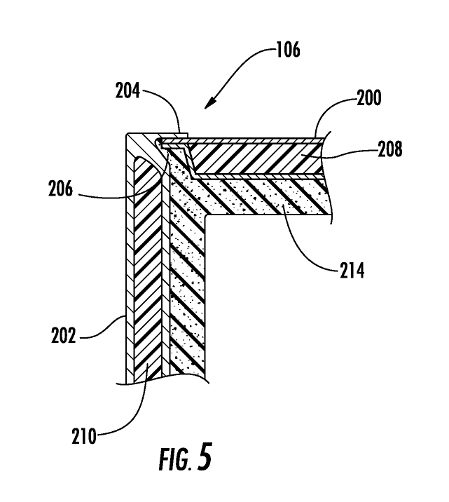

Referring to FIG. 5, a portion of outer case 106 is illustrated in accordance with the present disclosure. Outer case 106 includes top wall 200 and side wall 202. Although not illustrated, a second side wall can be joined to top wall as herein described. Top wall 200 and side wall 202 can each be separately formed as described herein and can each define a wall of a vacuum insulation panel. With reference again to FIG. 5, compartments 208, 210 define respective vacuum insulation panels of top wall 200 and side wall 202, respectively. Compartments 208, 210 are positioned between outer case 106 can inner liner 212 (which can be representative of both inner liner 108 and/or inner liner 110). Top wall 200 and side wall 202 interface along their respective side edges 204, 206. In this regard, top wall 200 edge 204 and side wall edge 206 can define complimentary shapes so that they can more easily be joined together.

In certain embodiments of the present disclosure, a layer of conventional insulation 214, such as foamed-in-place insulation, can be added to between compartments 208, 210 and inner liner 212. Such a configuration can increase cabinet stiffness and strength since the layers form a sandwich construction. Furthermore, the edges 204, 206 of the vacuum insulation panels are in the corners of the refrigerator outer wall where any additional heat loss can more easily be minimized by the layer 214.

Referring again to FIG. 1, inner liners 108 and 110 are molded from a suitable plastic material to form fresh food compartment 102 and freezer compartment 104, respectively. In an alternative embodiment, inner liners 108 and/or 110 are formed by bending and welding a sheet of a suitable metal, such as steel. The illustrative embodiment includes two separate inner liners 108 and 110, as refrigerator 100 is a relatively large capacity unit and separate liners add strength and are easier to maintain within manufacturing tolerances. In smaller refrigerators, a single liner is formed and a mullion spans between opposite sides of the liner to divide it into a freezer compartment and a fresh food compartment.

A breaker strip 112 extends between a case front flange and outer front edges of inner liners 108 and 110. Breaker strip 112 is formed from a suitable resilient material, such as an extruded acrylo-butadiene-styrene based material (commonly referred to as ABS).

The insulation in the space between inner liners 108 and 110 is covered by another strip of suitable resilient material, commonly referred to as a mullion 114. In this embodiment, mullion 114 is formed of an extruded ABS material. Breaker strip 112 and mullion 114 form a front face, and extend completely around inner peripheral edges of outer case 106 and vertically between inner liners 108 and 110. Mullion 114, the insulation between compartments, and a spaced wall of liners separating the compartments, may be collectively referred to herein as a center mullion wall 116.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator comprising:
an inner liner defining a storage compartment;
an outer wall comprising a vacuum insulation panel, the outer wall defining a hermetically sealed vacuum compartment wall, the compartment comprising filler insulating material and being evacuated of atmospheric gases, wherein the compartment is located between the outer wall and the inner liner.

2. A refrigerator as in claim 1, wherein the outer wall comprises a side wall.

3. A refrigerator as in claim 1, wherein the outer wall comprises a top wall.

4. A refrigerator as in claim 1, wherein the outer wall comprises a back wall.

5. A refrigerator as in claim 1, wherein the outer wall comprises a top wall and a side wall, the top wall and the side wall interfacing with one another along a portion of their respective edges.

6. A refrigerator as in claim 5, wherein the interface forms a corner of the refrigerator outer wall.

7. A refrigerator as in claim 1, further comprising a layer of insulating material.

8. A refrigerator as in claim 7, wherein the layer of insulating material is located between the compartment and the inner liner.

9. A refrigerator as in claim 1, wherein the filler insulating material comprises fiberglass, foamed insulation, or combinations thereof.

10. A refrigerator as in claim 1, wherein the outer wall comprises steel, aluminum, or combinations thereof.

11. A method of assembling a refrigerator comprising:
joining an inner liner defining a storage compartment with an outer wall, the outer wall comprising a vacuum insulation panel, the outer wall defining a hermetically sealed vacuum compartment wall, the compartment comprising filler insulating material and being evacuated of atmospheric gases, wherein the compartment is located between the outer wall and the inner liner.

12. A method as in claim 11, further comprising forming the outer wall, the method of forming the outer wall comprising:
forming the compartment of metal defining an interior space and an opening communicating with the interior space;
filling the interior space with filler insulating material of a density sufficient to oppose the atmospheric force on the compartment after evacuation of the interior space;
locating a brazing material adjacent the opening;
preheating the panel at atmospheric pressure to reduce the air density in the interior space;
placing the compartment in a vacuum chamber to evacuate the interior space; and
melting the brazing material in the vacuum chamber to seal the opening while maintaining the vacuum.

13. A method as in claim 12, further comprising utilizing a vacuum pump to further evacuate the interior space prior to melting the brazing material.

14. A method as in claim 11, wherein the outer wall comprises a side wall and a top wall.

15. A method as in claim 14, wherein the top wall and the side wall interface with one another along a portion of their respective edges.

16. A method as in claim 15, wherein the interface forms a corner of the refrigerator outer wall.

17. A method as in claim 11, further comprising a layer of insulating material.

18. A method as in claim 17, wherein the layer of insulating material is located between the compartment and the inner liner.

19. A method as in claim 11, wherein the filler insulating material comprises fiberglass, foamed insulation, or combinations thereof.

20. A method as in claim 11, wherein the outer wall comprises steel, aluminum, or combinations thereof.
